(19) United States
(12) Patent Application Publication
(10) Pub. No.: US 2023/0318142 A1
(43) Pub. Date: Oct. 5, 2023

(54) SOLID-STATE BATTERY

(71) Applicant: HONDA MOTOR CO., LTD., Tokyo (JP)

(72) Inventors: Takuya Taniuchi, Wako-shi (JP); Toshiyuki Ariga, Wako-shi (JP)

(21) Appl. No.: 18/125,852

(22) Filed: Mar. 24, 2023

(30) Foreign Application Priority Data
Mar. 31, 2022 (JP) 2022-059778

(51) Int. Cl. H01M 50/46; H01M 4/38; H01M 50/491; H01M 4/134

(52) U.S. Cl. CPC H01M 50/46; H01M 4/382; H01M 50/491; H01M 4/134; H01M 4/387

(57) ABSTRACT

A solid-state battery includes a plurality of positive electrode layer including positive-electrode-active-material-layer and positive electrode-current-collector-layer, a negative electrode layer including negative-electrode-active-material-layer and negative-electrode-current-collector-layer, and solid-electrolyte-layer disposed between positive electrode layer and the negative electrode layer, the solid-electrolyte-layer is longer than positive electrode layer and negative electrode layer in a first direction perpendicular to a stacking direction, the solid-electrolyte-layer is constituted by solid electrolyte sheet including porous substrate having cavities, and solid electrolyte which is filled in at least a part of the porous substrate, the solid electrolyte sheet has facing portion that faces positive-electrode-active-material-layer and negative-electrode-active-material-layer, and non-facing portion located on outer side of facing portion in the first direction, content percentage of solid electrolyte in non-facing portion is lower than content percentage of solid electrolyte in facing portion, and end portions in first direction of non-facing portions of neighboring solid-electrolyte-layers in stacking direction are bonded.

### CROSS-REFERENCE TO RELATED APPLICATION

Priority is claimed on Japanese Patent Application No. 2022-059778, filed Mar. 31, 2022, the content of which is incorporated herein by reference.

### BACKGROUND OF THE INVENTION

### Field of the Invention

The present invention relates to a solid-state battery.

### Description of Related Art

In recent years, in order to ensure access to affordable, reliable, sustainable and advanced energy for more people, research and development have been carried out on secondary batteries that contribute to energy efficiency. As such a secondary battery, research and development of a solid-state battery using a solid electrolyte instead of an organic solvent-based electrolyte is particularly active from the viewpoint of safety.

In the solid-state battery, in order to contribute to energy efficiency, methods to improve characteristics from the viewpoint of increasing capacity, suppressing an increase in resistance, and improving durability are being investigated (for example, Japanese Unexamined Patent Application, First Publication No. 2020-077488, Japanese Unexamined Patent Application, First Publication No. 2020-129519, and Japanese Unexamined Patent Application, First Publication No. 2015-162353).

### SUMMARY OF THE INVENTION

Incidentally, in a technology related to a solid-state battery, in order to improve energy efficiency, it is important to increase the capacity of the solid-state battery and improve cycling characteristics. However, when the solid-state battery is mounted on a vehicle, an electrode layer and a solid electrolyte layer may shift in an in-plane direction due to vibration, separation may occur at an interface between the electrode layer and the solid electrolyte layer, and cycling characteristics may decrease. Even in the solid-state batteries of Japanese Unexamined Patent Application, First Publication No. 2020-077488, Japanese Unexamined Patent Application, First Publication No. 2020-129519, and Japanese Unexamined Patent Application, First Publication No. 2015-162353, the shift between such layers or separation at the interface may occur, and there is room for improving the cycling characteristics.

An aspect of the present invention is directed to providing a solid-state battery with a high energy density and improved cycling characteristics.

An aspect of the present invention employs the following configurations.
[1] A solid-state battery according to an aspect of the present invention includes a plurality of (i) a positive electrode layer including a positive electrode active material layer and a positive electrode current collector layer, (ii) a negative electrode layer including a negative electrode active material layer and a negative electrode current collector layer, and (iii) a solid electrolyte layer disposed between the positive electrode layer and the negative electrode layer, the solid electrolyte layer is longer than the positive electrode layer and the negative electrode layer in a first direction perpendicular to a stacking direction, the solid electrolyte layer is constituted by a solid electrolyte sheet including a porous substrate having cavities, and a solid electrolyte which is filled in at least a part of the porous substrate, the solid electrolyte sheet has a facing portion that faces the positive electrode active material layer and the negative electrode active material layer, and a non-facing portion located on an outer side of the facing portion in the first direction, a content percentage of the solid electrolyte in the non-facing portion is lower than a content percentage of the solid electrolyte in the facing portion, and end portions in the first direction of the non-facing portions of the neighboring solid electrolyte layers in the stacking direction are bonded.
[2] In the solid-state battery according to the above-mentioned aspect, in a second direction perpendicular to the stacking direction and the first direction, the solid electrolyte layer may be longer than the positive electrode active material layer and the negative electrode active material layer.
[3] In the solid-state battery according to the above-mentioned aspect, the solid electrolyte layer may further have a second-direction-non-facing portion located on an outer side of the facing portion in the second direction, and a content percentage of the solid electrolyte in the second-direction-non-facing portion may be lower than a content percentage of the solid electrolyte in the facing portion.
[4] In the solid-state battery according to the above-mentioned aspect, in the first direction crossing the stacking direction, the negative electrode layer may be longer than the positive electrode layer, the non-facing portion may have an inner region which does not overlap the positive electrode layer and which overlaps the negative electrode layer, and an outer region located on an outer side of the inner region in the first direction, and a content percentage of the solid electrolyte in the outer region may be smaller than a content percentage of the solid electrolyte in the inner region.
[5] In the solid-state battery according to the above-mentioned aspect, the non-facing portion of the solid electrolyte layer may have a bonding region bonded to a non-facing portion of another solid electrolyte layer, and a non-bonding region closer to the facing portion than the bonding region in the first direction, and a length of the non-bonding region in the first direction may be greater than a thickness of the positive electrode active material layer.
[6] In the solid-state battery according to the above-mentioned aspect, wherein the negative electrode active material layer may include any one selected from the group consisting of an alloy obtained by combining metal lithium, lithium and another element or compound, and an alloy obtained by combining metal silicon, silicon and another element or compound, as a negative electrode active material.
[7] In the solid-state battery according to the above-mentioned aspect, a porosity of the porous substrate in the non-facing portion may be higher than a porosity of the porous substrate in the facing portion.

According to the aspects of the present invention, it is possible to provide a solid-state battery with a high energy density and improved cycling characteristics.

### BRIEF DESCRIPTION OF THE DRAWINGS

FIG. 1 is a cross-sectional view of a solid-state battery according to an embodiment of the present invention.

FIG. 2 is a cross-sectional view of the solid-state battery of FIG. 1 in another direction.

FIG. 3 is a plan view of a solid electrolyte layer provided in the solid-state battery of FIG. 1.

FIG. 4 is a cross-sectional view of the solid electrolyte layer provided in the solid-state battery of FIG. 1.

FIG. 5 is a cross-sectional view showing a variant of the solid-state battery of FIG. 1.

FIG. 6 is a plan view of the solid electrolyte layer provided in the solid-state battery of FIG. 5.

FIG. 7 is a plan view of a solid electrolyte layer provided in a solid-state battery of another variant.

FIG. 8 is a cross-sectional view showing a variant of the solid-state battery of FIG. 1.

FIG. 9 is a cross-sectional view showing a variant of the solid-state battery of FIG. 1.

### DETAILED DESCRIPTION OF THE INVENTION

Hereinafter, an example of an embodiment of the present invention will be described in detail with reference to the accompanying drawings. Further, in the drawings used in the following description, in order to make it easier to understand features of the present invention, feature parts may be enlarged for convenience. For this reason, dimensional ratios of components may differ from actual ones.

### [Solid-State Battery]

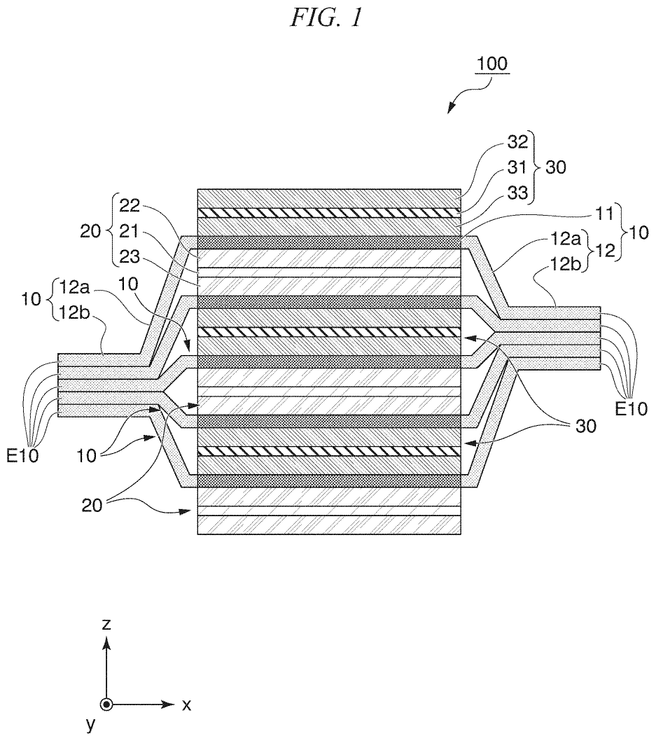

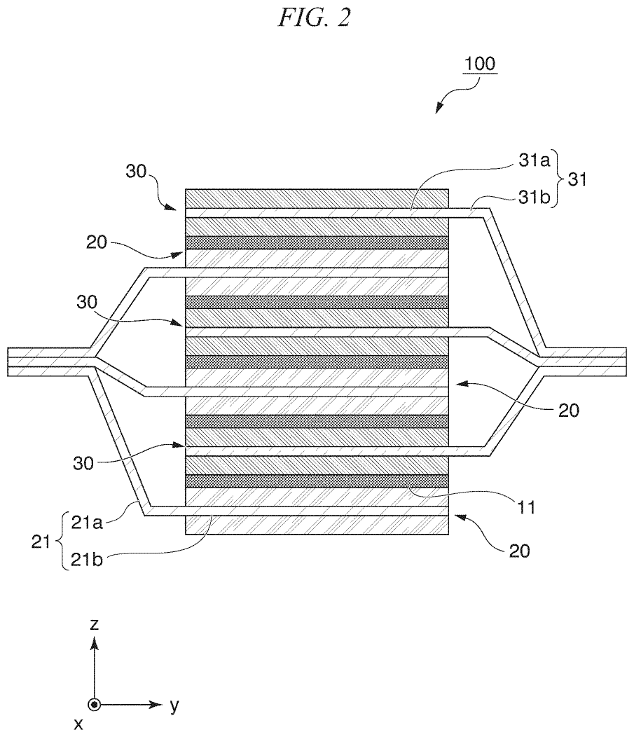

FIG. 1 is a cross-sectional view of a solid-state battery according to an embodiment of the present invention, and FIG. 2 is a cross-sectional view of the solid-state battery of FIG. 1 in another direction.

The solid-state battery 100 shown in FIGS. 1 and 2 includes a plurality of (i) a positive electrode layer 20 including positive electrode active material layers 22 and 23 and a positive electrode current collector layer 21, (ii) a negative electrode layer 30 including negative electrode active material layers 32 and 33 and a negative electrode current collector layer 31, and (iii) a solid electrolyte layer 10 disposed between the positive electrode layer 20 and the negative electrode layer 30. In a first direction (an x direction in FIGS. 1 and 2) in an in-plane direction perpendicular to a stacking direction (a z direction in FIGS. 1 and 2), the solid electrolyte layer 10 is longer than the positive electrode layer 20 and the negative electrode layer 30. The solid electrolyte layer 10 is constituted by a solid electrolyte sheet, the solid electrolyte sheet has (i) a facing portion 11 that faces the positive electrode active material layers 22 and 23 and the negative electrode active material layers 32 and 33 and (ii) a non-facing portion 12 located at an outer side of the facing portion 11 in the x direction. A content percentage of a solid electrolyte 16 in the non-facing portion 12 is lower than a content percentage of the solid electrolyte 16 in the facing portion 11. End portions E10 of the non-facing portion 12 of the solid electrolyte layer 10 in the first direction, which are next to each other in the stacking direction, are bonded.

### <Positive Electrode Layer>

The positive electrode layer 20 has the positive electrode current collector layer 21, and the positive electrode active material layers 22 and 23 provided on at least one side of a main surface of the positive electrode current collector layer 21. FIGS. 1 and 2 show an example in which the positive electrode active material layers 22 and 23 are formed on both main surfaces of the positive electrode current collector layer 21.

The positive electrode current collector layer 21 is formed of, for example, a material having high conductivity. The positive electrode current collector layers 21 extend, for example, in the second direction (y direction) perpendicular to the stacking direction and the first direction, extend in a −y direction in the example shown in FIGS. 1 and 2, and then are bundled. The positive electrode current collector layer 21 has an overlapping portion 21b sandwiched between the positive electrode active material layers 22 and 23, and an extension portion 21a extending from the overlapping portion 21b in the −y direction. A place where the positive electrode current collector layers 21 are bundled may be referred to as a tab.

The positive electrode active material layers 22 and 23 include a positive electrode active material. As the positive electrode active material, for example, among sulfides, titanium sulfide (TiS₂), molybdenum sulfide (MoS₂), iron sulfide (FeS, FeS₂), copper sulfide (CuS), nickel sulfide (Ni₃S₂), and the like are exemplified. In addition, among oxides, bismuth oxide (Bi₂O₃), bismuth plumbate (Bi₂Pb₂O₅), copper oxide (CuO), vanadium oxide (V₆O₁₃), lithium cobalt oxide (LiCoO₂), lithium nickel oxide (LiNiO₂), lithium manganese oxide (LiMnO₂), Li(NiCoMn)O₂, Li(NiCoAl)O₂, Li(NiCo)O₂, and the like are exemplified.

In addition, they may be mixed and used. The positive electrode active material layers 22 and 23 may include a binder, a conductive assistant, or the like.

### <Negative Electrode Layer>

The negative electrode layer 30 has the negative electrode current collector layer 31, and the negative electrode active material layers 32 and 33 provided on at least one side of main surfaces of the negative electrode current collector layer 31. In FIGS. 1 and 2, an example in which the negative electrode active material layers 32 and 33 are formed on both the main surfaces of the negative electrode current collector layer 31 is shown. The negative electrode layers 30 and the positive electrode layers 20 are alternately stacked via the solid electrolyte layer 10 as shown in FIGS. 1 and 2.

The negative electrode current collector layer 31 is formed of, for example, a material having high conductivity. The negative electrode current collector layers 31 extend, for example, in a +y direction and are bundled. The negative electrode current collector layer 31 has an overlapping portion 31a sandwiched between the negative electrode active material layers 32 and 33, and an extension portion 31b extending from the overlapping portion 31a in the +y direction. A place where the negative electrode current collector layers 31 are bundled may be referred to as a tab.

The negative electrode active material layers 32 and 33 include a negative electrode active material. As the negative electrode active material, for example, a carbon material, specifically, graphite, hard carbon, artificial graphite, graphite carbon fiber, resin baking carbon, pyrolysis vapor growth carbon, cokes, mesocarbon microbeads (MCMB), furfuryl alcohol resin baking carbon, polyacene, pitch-based carbon fiber, vapor growth carbon fiber, natural graphite, non-graphiting carbon, and the like, are exemplified. Alternatively, a mixture thereof may be provided. In addition, a metal itself such as metal lithium, metal indium, metal aluminum, metal silicon, metal tin, or the like, an alloy obtained by combining these metals with another element or compound, or lithium titanate (Li₄Ti₅O₁₂) is exemplified.

When an alloy obtained by combining metal lithium or lithium with another element or oxide is used as the negative electrode active material, dendrites may occur on the negative electrode active material layers 32 and 33, and in such a case, there is concern about a decrease in adhesion at the interface between the negative electrode active material layers 32 and 33 and the solid electrolyte layer 10. However, according to the solid-state battery 100 related to the embodiment, as will be described below in detail, even when such a material is used as the negative electrode active material, it is possible to suppress a decrease in adhesion between the negative electrode active material layers 32 and 33 and the solid electrolyte layer 10 and improve cycling characteristics. In addition, while the negative electrode active material layers 32 and 33 containing the alloy obtained by combining the metal silicon or silicon with another element or compound as the negative electrode active material are likely to expand and shrink upon charging or discharging, according to the embodiment, as described below in detail, even when such a negative electrode active material is used, it is possible to suppress a decrease in adhesion between the negative electrode active material layers 32 and 33 and the solid electrolyte layer 10 and improve cycling characteristics.

The negative electrode active material layers 32 and 33 may include a binder, a conductive assistant, or the like.

In the solid-state battery 100, two materials are selected from the materials selected as exemplified above, and in comparison with charging/discharging potential of two types of compounds, a material showing electropositive potential is used as a positive electrode active material, and a material showing electronegative potential is used as a negative electrode active material.

### <Solid Electrolyte Layer>

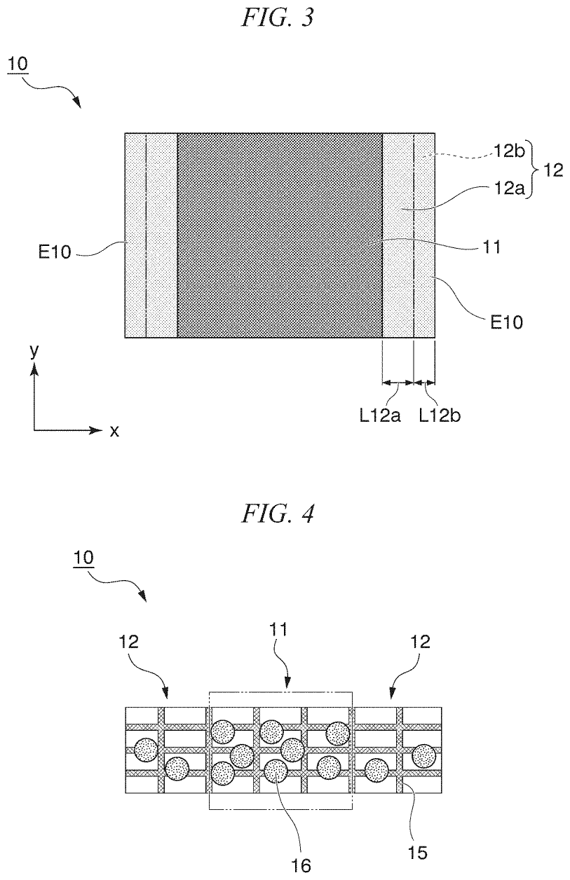

The solid electrolyte layer 10 is disposed between the positive electrode layer 20 and the negative electrode layer 30 in the z direction. FIG. 3 is a plan view of the solid electrolyte layer 10, and FIG. 4 is a cross-sectional view of the solid electrolyte layer 10. The solid electrolyte layer 10 is longer than the positive electrode layer 20 and the negative electrode layer 30 in the x direction. The solid electrolyte layer 10 is constituted by a solid electrolyte sheet. The solid electrolyte layer 10 is constituted by the solid electrolyte sheet including a porous substrate 15 in which cavity is formed, and the solid electrolyte 16 which is filled in at least a part of the porous substrate 15. The solid electrolyte sheet may include, for example, a binder. The solid electrolyte sheet is constituted by, for example, the porous substrate 15, the solid electrolyte 16 and the binder. A shape of the solid electrolyte layer 10 when seen in a plan view may be a circular shape or the like.

### (Solid Electrolyte Sheet)

The solid electrolyte sheet has the facing portion 11 that faces the positive electrode active material layers 22 and 23 and the negative electrode active material layers 32 and 33, and the non-facing portion 12 located on an outer side of the facing portion 11 in the x direction. That is, the facing portion 11 overlaps the positive electrode active material layers 22 and 23 and the negative electrode active material layers 32 and 33, and the non-facing portion 12 does not overlap the active material layer of at least one of the positive electrode active material layers 22 and 23 and the negative electrode active material layers 32 and 33. The non-facing portions 12 are disposed to sandwich the facing portion 11 in the x direction, for example, as shown in FIG. 3.

A content percentage of the solid electrolyte 16 in the non-facing portion 12 of the solid electrolyte sheet is lower than a content percentage of the solid electrolyte in the facing portion 11, and for example, preferably 0.5 times or less the content percentage of the solid electrolyte in the facing portion 11. Here, in the predetermined region of the solid electrolyte sheet constituted by the solid electrolyte 16, the porous substrate 15 and the binder, a sum of the content percentage of the solid electrolyte, the content percentage of the porous substrate and the content percentage of the binder is 100 (mass %). The content percentage of the solid electrolyte in the facing portion 11 is, for example, 10.0 to 99.9 (mass %), preferably 50.0 to 99.9 (mass %), and more preferably 70.0 to 99.9 (mass %). The content percentage of the solid electrolyte in the non-facing portion 12 is, for example, less than 99.9 (mass %), preferably 1.0 to 70.0 (mass %), and more preferably 50.0 (mass %) or less. The non-facing portion 12 may not contain the solid electrolyte.

The remainder in the solid electrolyte sheet is the binder and the porous substrate 15. The content percentage of the binder in the non-facing portion 12 of the solid electrolyte sheet is higher than the content percentage of the binder in the facing portion 11, and for example, preferably 1 times or more the content percentage of the binder in the facing portion 11. The content percentage of the binder in the facing portion 11 is, for example, 0.1 to 50.0 (mass %), preferably 0.1 to 20.0 (mass %), and more preferably 0.1 to 10.0 (mass %).

In this case, the non-facing portion 12 is constituted by, for example, the porous substrate 15, or constituted by the porous substrate 15 and the binder.

Here, the content percentage (mass %) of the solid electrolyte in the predetermined region of the solid electrolyte sheet can be measured by utilizing, for example, thermogravimetry (TG measurement) and an electron probe micro analyzer (EPMA). Specifically, first, for example, the cell is disassembled, the non-facing portion 12 of the solid electrolyte sheet is cut out, and the weight of the non-facing portion 12 is measured by the thermogravimetry. Next, the content amount in each of the facing portion 11 and the non-facing portion 12 in the solid electrolyte sheet can be measured by the electron probe micro analyzer, the content amount can be divided by an area of each of the facing portion 11 and the non-facing portion 12 when seen in a plan view in the stacking direction, a ratio of the solid electrolyte content percentage in the facing portion 11 with respect to the non-facing portion 12 can be calculated, and the weight of the facing portion 11 can also be calculated by multiplying the weight of the non-facing portion 12 by the above mentioned ratio. In addition, the thickness of the facing portion 11 and the non-facing portion 12 can be measured, and the content percentage of the solid electrolyte in the facing portion 11 and the non-facing portion 12 can be calculated by dividing each of the weight of the facing portion 11 and the non-facing portion 12 by (the thickness of the facing portion 11 (, or the non-facing portion 12)×the area of the facing portion 11 (, or the non-facing portion 12)). The facing portion 11 preferably has a smaller filling rate of the solid electrolyte than that of the non-facing portion 12. A numerical value range of the filling rate of the solid electrolyte may be the same as that of the content percentage of the solid electrolyte. A filling rate of the solid electrolyte in the predetermined region of the solid electrolyte sheet is calculated by dividing the weight of the solid electrolyte sheet in the predetermined region by the area of the region.

The end portion E10 of the solid electrolyte layer 10 in the x direction is bonded to the end portion E10 of the adjacent solid electrolyte layer 10 in the x direction. That is, in the plurality of solid electrolyte layers 10 provided in the solid-state battery 100, the predetermined solid electrolyte layer 10 is bonded to the end portion E10 in the x direction of the solid electrolyte layer 10 among at least one of the two neighboring solid electrolyte layers 10 in the z direction. From the viewpoint of improving the adhesion between the solid electrolyte layer 10 and the positive electrode layer 20 and the adhesion between the solid electrolyte layer 10 and the negative electrode layer 30, the number of the solid electrolyte layers 10 bonded at the same place is preferably large, and all the end portions E10 of the plurality of solid electrolyte layers 10 provided in the solid-state battery 100 may be bonded at one place in each of the +x direction and the −x direction.

A bonding means of the end portions E10 may be an arbitrary means, for example, sealing such as heat welding or the like, pinned, binding, winding, crimping, bundling by a resin, or the like. The bonding means of the end portions E10 is preferably the sealing from the viewpoint of suppressing contaminant intrusion from the outside or improving stability. Hereinafter, a case in which the bonding means is the heat welding will be described exemplarily in the embodiment. In the embodiment, in the solid electrolyte sheet, a region bonded to the adjacent solid electrolyte sheet in the z direction may be referred to as a bonding region 12b. The bonding region 12b is located at, for example, both ends of the solid electrolyte layer 10 in the x direction, and extends in the y direction from an end portion in the +y direction to an end portion in the −y direction. A length (width) L12b of the bonding region 12b in the x direction may be, for example, 0.1 mm to 20 mm, and preferably 0.1 mm to 5 mm.

The non-facing portion 12 has, for example, a bonding region 12b bonded to the non-facing portion 12 of the adjacent solid electrolyte layer 10 in the z direction, and a non-bonding region 12a closer to the facing portion 11 than the bonding region 12b in the x direction. A ratio (L12a/L12b) of a length L12a of the non-bonding region 12a and the length L12b of the bonding region 12b in the x direction may be arbitrary. The length L12b of the bonding region 12b in the x direction is preferably greater than the thickness of the positive electrode active material layers 22 and 23.

The porous substrate 15 is formed of, for example, a porous material. The porous substrate 15 is, for example, a support body that supports the solid electrolyte 16 and the binder (not shown). The porous substrate 15 is, for example, woven fabric, non-woven fabric, or the like, and cavities may be formed in the substrate expanding in the in-plane direction. A thickness of the porous substrate 15 is, for example, 5 μm or more and less than 20 μm. The porosity of the porous substrate 15 is, for example, 60% or more and 95% or less. Since the porosity of the porous substrate 15 is within the above-mentioned range, a decrease in ion conductance is suppressed, and stability when standing on its own is increased. Further, the thickness of the porous substrate 15 may differ between the facing portion 11 and the non-facing portion 12. For example, the thickness of the porous substrate 15 in the facing portion 11 may be greater than that of the porous substrate in the non-facing portion 12, and by such a configuration, even when the solid electrolyte 16 is uniformly applied in the surface, the pressing pressure against the solid electrolyte sheet can be adjusted, and the content percentage of the solid electrolyte in the facing portion 11 and the non-facing portion 12 can be varied. When the solid electrolyte 16 is uniformly applied in the surface, the thickness of the non-facing portion 12 is preferably greater than one times and less than five times the thickness of the facing portion 11, and more preferably two times or less. In this way, since the thickness in the non-facing portion 12 is large and the content percentage of the solid electrolyte per volume is low, i.e., the weight per volume is small, and bending breaking is less likely to occur.

The porosity of the porous substrate 15 in the bonding region 12b may be lower than the porosity of the porous substrate 15 in the non-bonding region 12a. For example, the porosity of the porous substrate 15 in the bonding region 12b may be 0.5 times or less or 0.1 times or less the porosity of the porous substrate 15 in the non-bonding region 12a. In addition, a resin may be formed in the bonding region 12b.

Here, the porosity of the porous substrate 15 means the ratio of gaps per unit volume is shown as a percentage. Specifically, the porosity is calculated from a basis weight (g/m²), a porous substrate thickness (μm), and a density (g/cm³) of the porous substrate material of the porous substrate 15 using the following equation (1).

Porosity (%)=[{1−basis weight (g/m²)}/{porous substrate thickness (μm)}]/{density (g/cm³) of porous substrate material} (1)

Here, the basis weight means the weight (g) per area 1 m² of the porous substrate 15 when seen in a plan view in the stacking direction, the porous substrate thickness means the thickness (μm) of the porous substrate 15 alone, and the density of the porous substrate material means the density (g/cm³) of the material that constitutes the porous substrate 15.

For example, the porosity of the porous substrate 15 may differ between the facing portion 11 and the non-facing portion 12 by using the porous substrate that differs for each region. When a thick fiber material is used as the porous substrate 15, the porosity of the porous substrate 15 is reduced. In the porous substrate 15, from the viewpoint of suppressing the bending breaking, the porosity of the porous substrate 15 in the non-facing portion 12 is preferably lower than the porosity of the porous substrate 15 in the facing portion 11, more preferably 0.1 to 1 times the porosity of the porous substrate 15 in the facing portion 11, and further preferably 0.1 to 0.5 times the porosity of the porous substrate 15 in the facing portion 11.

The porous substrate 15 is formed of, for example, a material capable of forming a self-standing solid electrolyte sheet. The porous substrate 15 is formed of, for example, polyethylene terephthalate, nylon, aramid, Al₂O₃, glass, or the like. The porous substrate 15 is preferably constituted by a heat resistance fiber from the viewpoint of suppressing occurrence of short circuit and interface resistance during high-temperature pressing in the manufacturing process. Specifically, in the above-mentioned materials, it is preferable to use aramid or Al₂O₃.

As the solid electrolyte 16, the solid electrolyte containing a lithium element is preferably used. Among these, a material including at least lithium sulfide as a first ingredient, and synthesized by one or more compound selected from the group consisting of silicon sulfide, phosphorus sulfide and boron sulfide is preferable as a second ingredient, and Li₂S—P₂S₅ is particularly preferable from the viewpoint of lithium ionic conductivity.

When the solid electrolyte 16 is a sulfide-based electrolyte, the solid electrolyte may further contain sulfide such as SiS₂, GeS₂, B₂S₃, or the like. In addition, Li₃PO₄, halogen, halogen compound, or the like, may be added to the solid electrolyte as appropriate.

When the solid electrolyte used in the solid electrolyte sheet of the present invention is a lithium ionic conductor formed of inorganic compound, for example, Li₃N, LISICON, LIPON (Li_{3+y}PO₄−XNₓ), Thio-LISICON (Li_{3.25}Ge_{0.25}P_{0.75}S₄), Li₂O—Al₂O₃—TiO₂—P₂O₅ (LATP), or the like, is exemplified.

The solid electrolyte used in the solid electrolyte sheet of the present invention may have a structure such as amorphous, vitrified, crystal (crystallized glass), or the like. When the solid electrolyte is a sulfide-based solid electrolyte formed of Li₂S—P₂S₅, a lithium ionic conductance of the amorphous body is about 10⁻⁴ Scm⁻¹. Meanwhile, the lithium ionic conductance in the case of the crystalline body is about 10⁻³ Scm⁻¹. In addition, the solid electrolyte 16 preferably further contains at least one selected from phosphor and sulfur. Since the solid electrolyte 16 contains at least one selected from phosphor and sulfur, the ion conductance of the solid-state battery 100 can be improved.

According to the solid-state battery 100, since the end portions E10 in the x direction of the non-facing portions 12 of the neighboring solid electrolyte layers 10 in the stacking direction are bonded, even when the solid-state battery 100 is vibrated, it is possible to suppress occurrence of pulsation in each layer. For example, it is possible to suppress the positive electrode layer 20 and the negative electrode layer 30 extending for connection with the external power supply from resonating and breaking or cracking. That is, it is possible to suppress the positive electrode layer 20 and the solid electrolyte layer 10, and the negative electrode layer 30 and the solid electrolyte layer 10 from shifting in the in-plane direction together with due to vibrations, suppress occurrence of separation on the interface between the layers, suppress occurrence short circuit due to a crack or the like, and improve cycling characteristics. In addition, intrusion of contaminants or chemical small short circuit is likely to be suppressed. Such a structure is a structure that can be realized because the content percentage of the solid electrolyte in the non-facing portion 12 is lower than the content percentage of the solid electrolyte in the facing portion 11.

In addition, since the solid electrolyte layer 10 provided in the solid-state battery 100 is constituted by the solid electrolyte sheet including the porous substrate 15 having cavities, and the solid electrolyte 16 which is filled in the porous substrate 15, it is possible to realize a thin solid electrolyte layer 10 with high durability. Accordingly, high energy density and low resistance can be achieved. In the solid-state battery 100, the amount of the solid electrolyte 16 filled in the non-facing portion 12, which does not contribute much to charging and discharging, is small, and cost reduction can also be achieved.

### [Variant]

The solid-state battery according to the embodiment is not limited to the solid-state battery 100 shown in FIGS. 1 and 2, and various modifications may be made without departing from the scope of the claims. While a variant of the solid-state battery 100 will be described below, in the drawings of the variant, the same components as in the solid-state battery 100 are designated by the same reference signs, and description thereof will be omitted.

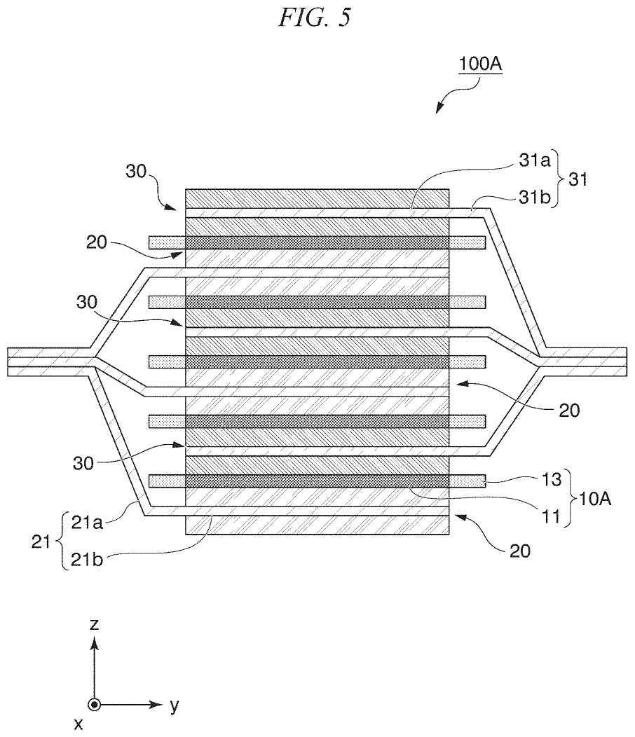

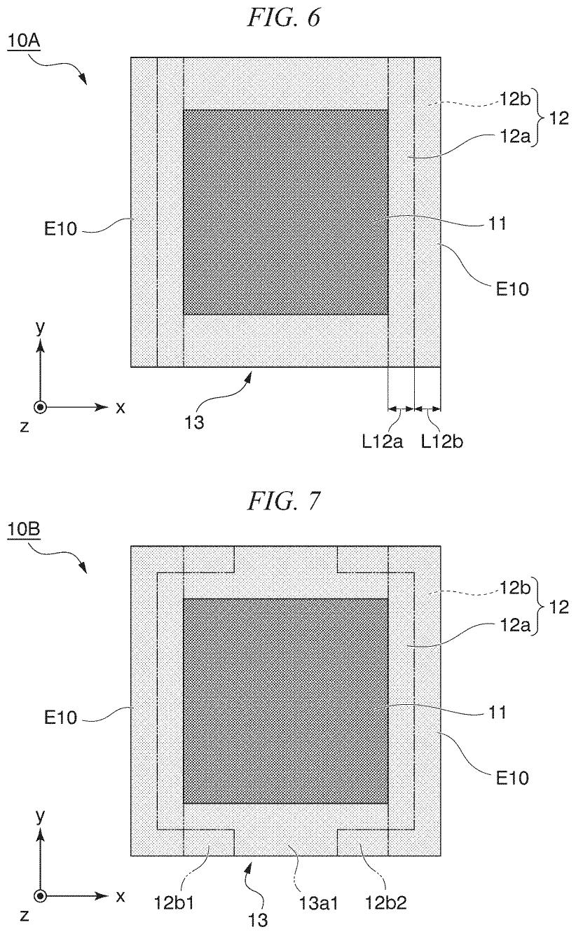

For example, the solid-state battery according to the embodiment may be a solid-state battery as shown in FIG. 5. FIG. 5 is a cross-sectional view showing a variant of the solid-state battery of FIG. 1. FIG. 6 is a plan view of a solid electrolyte layer provided in the solid-state battery of FIG. 5. A configuration of a solid electrolyte layer 10A of a solid-state battery 100A is distinguished from that of the solid electrolyte layer 10 of the solid-state battery 100.

The solid electrolyte layer 10A is longer than the positive electrode active material layers 22 and 23 and the negative electrode active material layers 32 and 33 in the y direction perpendicular to the x direction and the z direction. A length of the solid electrolyte layer 10A in the y direction is equal to or greater than a length of the positive electrode active material layers 22 and 23 and the negative electrode active material layers 32 and 33 in the y direction, and preferably greater than the length of the positive electrode active material layers 22 and 23 and the negative electrode active material layers 32 and 33 in the y direction by 0.1 mm or more, or by 0.5 mm or more. When the length of the solid electrolyte layer 10A in the y direction is greater than the length of the positive electrode active material layers 22 and 23 and the negative electrode active material layers 32 and 33 in the y direction, it is easy to obtain an effect of suppressing short circuit of the positive electrode layer 20 and the negative electrode layer 30 in the y direction.

The above-mentioned solid electrolyte layer 10A further has a second-direction-non-facing portion 13 located on an outer side of the facing portion 11 in the y direction. The content percentage of the solid electrolyte in the second-direction-non-facing portion 13 may be, for example, equal to or smaller than the content percentage of the solid electrolyte in the facing portion 11, or may be the same as the content percentage of the solid electrolyte in the non-facing portion 12.

In addition, the second-direction-non-facing portion 13 may be wound on the extension portion 21a of the positive electrode current collector layer 21 bundled in the −y direction, or may be wound on the extension portion 31b of the negative electrode current collector layer 31 bundled in the +y direction. That is, the second-direction-non-facing portion 13 may be inclined from a surface (xy plane) on which the facing portion 11 expands. In addition, the second-direction-non-facing portion 13 may be configured such that a region close to the facing portion 11 expands in an xy plane and a region further separated from the facing portion 11 than such region is inclined from the xy plane.

Since the second-direction-non-facing portion 13 has the above-mentioned shape, vibrations of the second-direction-non-facing portion 13 are limited by the extension portion 21a of the positive electrode current collector layer 21 and the extension portion 31b of the negative electrode current collector layer 31, and cracks caused by the vibrations can be prevented. Here, an angle of the inclined portion of the second-direction-non-facing portion 13 with respect to the xy plane is equal to or less than the bending breaking of the solid electrolyte layer.

In addition, for example, the solid-state battery according to the embodiment may be a solid-state battery including a solid electrolyte layer 10B as shown in FIG. 7. In the solid electrolyte layer 10B, a bonding region 12b further has inner bonding regions 12b1 and 12b2 extending in the x direction. That is, a shape of the bonding region 12b when seen in a plan view is a C shape, and the inner bonding regions 12b1 and 12b2 extend in a direction crossing the direction in which the positive electrode layer 20 and the negative electrode layer 30 extend. The inner bonding regions 12b1 and 12b2 sandwich an inner non-bonding region 13a1 including, for example, regions located in the y direction with respect to the facing portion 11.

The positive electrode current collector layer 21 and the negative electrode current collector layer 31 of the solid-state battery including the solid electrolyte layer 10A overlap the inner non-bonding region 13a1 located in the −y direction and the inner non-bonding region 13a1 located in the +y direction in the stacking direction, extend in an outer region of the solid electrolyte layer 10A in the y direction, and is connected to an external power supply. The positive electrode current collector layer 21 and the negative electrode current collector layer 31 may be formed such that the length of the region overlapping the non-facing portion 12 in the x direction is smaller than the region overlapping the facing portion 11.

In addition, the solid electrolyte layer 10B may be cut out along a shape of the non-bonding region 12a (a two-dot chain line in the drawings). In this case, an outer circumference of the solid electrolyte layer 10B is bonded to the adjacent solid electrolyte layer 10B in the stacking direction.

According to the solid-state battery including the solid electrolyte layer 10B, since the inner bonding regions 12b1 and 12b2 are provided, contaminant intrusion from the outside can be further suppressed, adhesion of the solid electrolyte layer 10B and the positive electrode layer 20 and adhesion of the solid electrolyte layer 10B and the negative electrode layer 30 can be further improved, and cycling characteristics can be further improved.

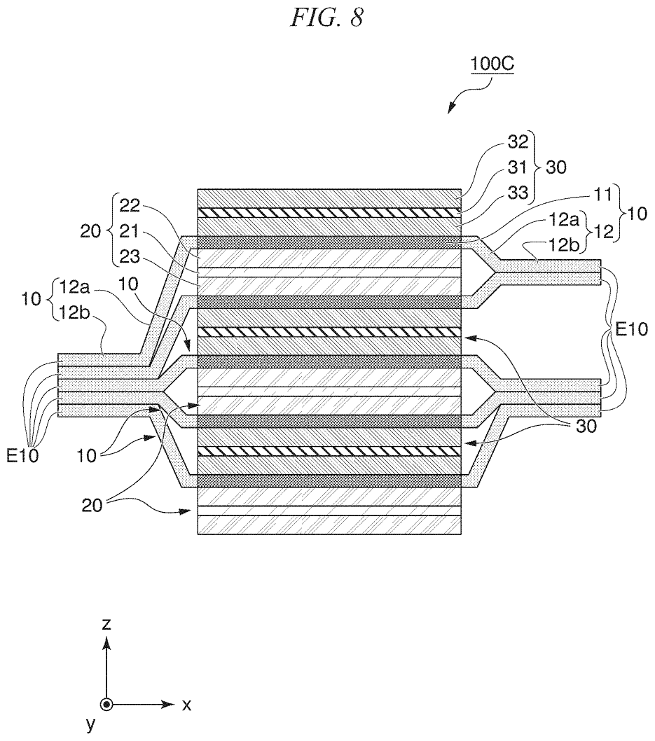

In addition, for example, a solid-state battery 100C as shown in FIG. 8 may be provided. FIG. 8 is a cross-sectional view of another variant of the solid-state battery, showing a cross section in the y direction. The solid-state battery 100C is different from the solid-state battery 100 shown in FIG. 1 how the solid electrolyte layer 10 is bonded. The solid-state battery 100C is distinguished from the solid-state battery 100 in that the end portions E10 of all the solid electrolyte layers 10 in the +x direction are unbonded at one place. In the solid-state battery of the embodiment, it is sufficient as long as the end portions in the x direction of the neighboring solid electrolyte layers in the stacking direction are bonded. That is, regarding a certain solid electrolyte layer 10, it is sufficient as long as a solid electrolyte layer 10 of any one adjacent to the certain solid electrolyte layer 10 in the stacking direction and the end portion E10 in the x direction are bonded. In the solid-state battery 100C, the end portions E10 of each of the solid electrolyte layers 10 in the x direction are bonded to the end portion E10 of any one of the neighboring solid electrolyte layers 10 in the x direction in the stacking direction. The solid-state battery 100C has a region in which the end portions E10 of the solid electrolyte layers 10 in the x direction are bonded at a plurality of places in the stacking direction.

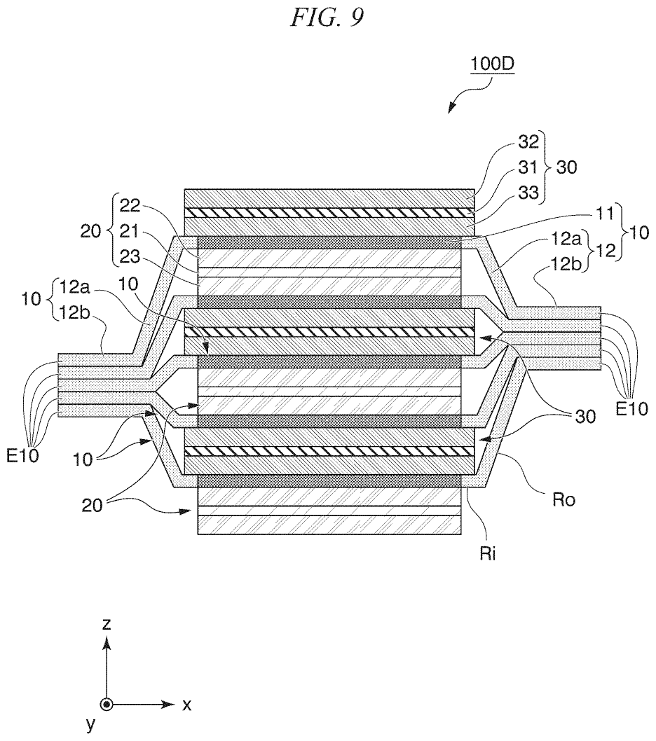

In addition, for example, a solid-state battery 100D as shown in FIG. 9 may be provided. FIG. 9 is a cross-sectional view of another variant of the solid-state battery, showing a cross section in the y direction. The solid-state battery 100D is distinguished from the solid-state battery 100 in that the negative electrode layer 30 is longer than the positive electrode layer 20 in the x direction. The negative electrode layer 30 may be longer than the positive electrode layer 20 even in the y direction. In the solid-state battery 100D, the solid electrolyte layer 10 has an inner region Ri overlapping the negative electrode layer 30 while not overlapping the positive electrode layer 20, and an outer region Ro located on an outer side of the inner region in the x direction. The outer region Ro does not overlap the positive electrode layer 20 and the negative electrode layer 30. The outer region Ro may sandwich the inner region Ri at least in the x direction, and may also sandwich the inner region Ri even in the y direction. That is, the outer region Ro may be provided so as to surround the inner region Ri when seen in a plan view in the stacking direction.

The content percentage of the solid electrolyte in the outer region Ro may be preferably, for example, equal to or less than the content percentage of the solid electrolyte in the inner region Ri, or may be preferably smaller than the content percentage of the solid electrolyte in the inner region Ri.

Even if there is a stacking variation, from the viewpoint of suppressing occurrence of performance variation, the content percentage of the solid electrolyte in the inner region Ri may be the same as the content percentage of the solid electrolyte in the facing portion 11. In this case, the content percentage of the solid electrolyte in the outer region Ro is lower than the content percentage of the solid electrolyte in the inner region Ri. According to the above-mentioned configuration, a value obtained by dividing the content amount of the solid electrolyte in the facing portion 11 by the area of the facing portion 11 is greater than a value obtained by dividing the content amount of the solid electrolyte in the non-facing portion 12 by the area of the non-facing portion 12.

That is, the content percentage of the solid electrolyte in the facing portion 11 is greater than the content percentage of the solid electrolyte in the non-facing portion 12.

### [Method of Manufacturing Solid-State Battery]

A method of manufacturing a solid-state battery according to the embodiment has, for example, a positive electrode sheet forming process, a negative electrode sheet forming process, a solid electrolyte sheet forming process, a stacking process and a bonding process. Hereinafter, an example of the method of manufacturing the solid-state battery 100A shown in FIGS. 1 and 2 will be described.

### <Positive Electrode Sheet Forming Process>

First, a positive electrode current collector and a positive electrode active material layer are pressurized in a stacked state to form a positive electrode sheet (a positive electrode sheet forming process).

### <Negative Electrode Sheet Forming Process>

Next, a negative electrode current collector and a negative electrode active material layer are pressurized in a stacked state to form a negative electrode sheet (a negative electrode sheet forming process).

### <Solid Electrolyte Sheet Forming Process>

Next, for example, slurry obtained by dissolving the solid electrolyte 16 in a solvent is prepared, and the prepared slurry is applied to the predetermined region on one or both surfaces of the porous substrate 15 and dried to form a solid electrolyte sheet (solid electrolyte sheet forming process). The solvent used for preparing the slurry containing the solid electrolyte 16 is not particularly limited as long as it does not exert a bad influence on performance of the solid electrolyte 16. For example, a non-aqueous solvent such as butyl butyrate or the like is exemplified.

As an application method of applying the slurry containing the solid electrolyte 16 on a predetermined region of one or both surfaces of the porous substrate 15, for example, slide die coat, comma die coat, comma reverse coat, gravure coat, gravure reverse coat, spray coating, or the like, may be exemplified. The slurry containing the solid electrolyte 16 is applied to a region that becomes at least the facing portion 11. In the solid electrolyte sheet forming process, the slurry containing the solid electrolyte 16 may be applied to only the region that becomes the facing portion 11, the slurry with a high solid electrolyte concentration may be applied to the region that becomes the facing portion 11, and the slurry with a low solid electrolyte concentration may be applied to a region that becomes outside the facing portion 11 in the x direction or a region that becomes the non-facing portion 12.

The solid electrolyte concentration in the facing portion 11 and the non-facing portion 12 is adjusted by, for example, a method of applying slurry with different solid electrolyte concentrations and a method of applying slurry containing a solid electrolyte to only the facing portion 11. For example, the slurry containing the solid electrolyte can be applied by adjusting the width of the blade to the width of the region that is the facing portion 11 and performing gravure coating.

Next, a sheet coated with the slurry containing the solid electrolyte is dried. Drying of the sheet can be performed by, for example, a dryer using hot blast, a heater, a high frequency, or the like.

While the sheet can be used as it is after drying, it can also be pressurized to increase strength or density thereof. As the pressurizing method, for example, sheet pressing, roll pressing, or the like, can be exemplified. Upon pressurization, different pressures may be applied to the facing portion 11 and the non-facing portion 12. For example, a large pressure may be applied to the facing portion 11 and a small pressure may be applied to the non-facing portion 12.

In addition, as a separate method, a method of forming a sheet using the solid electrolyte 16 in a powder without making slurry is exemplified. As such a method, a sandblasting method (SB method), an aerosol deposition method (AD method), or the like, may be exemplified, the solid electrolyte 16 may be collided at high speed and deposited and filled in the opening of the porous substrate, or the solid electrolyte 16 may be directly thermally sprayed. In addition, an autoclave method or a method of pressurizing a sheet obtained by placing powder of the solid electrolyte 16 on the porous substrate 15 using a press machine may be employed. The autoclave method is a method of placing powder of the solid electrolyte on the porous substrate in an inert gas, suctioning the solid electrolyte from below the porous substrate, and filling the porous substrate with the solid electrolyte.

In order to adjust the solid electrolyte content percentages of the facing portion 11 and the non-facing portion 12 using the above-mentioned method of not using the slurry, for example, a position that becomes the non-facing portion 12 is coated with a coating material such as a resin or the like to support the solid electrolyte 16 on the porous substrate 15, and then, the coating material may be separated.

### <Stacking Process>

Next, the solid electrolyte sheet is disposed between the positive electrode sheet and the negative electrode sheet, and these are attached and bonded (a stacking process). The stacking process can be performed by, for example, a method of pressurizing and pressure-joining them using a press machine or the like, or a method of pressurizing them between two rolls (roll to roll).

### <Bonding Process>

Next, the end portions in the x direction of the non-facing portions 12 of the neighboring solid electrolyte layers 10 in the stacking direction are bonded (a bonding process). The bonding of the neighboring solid electrolyte layers 10 in the stacking direction can be performed by a means, for example, sealing such as heat welding or the like, pinned, binding, winding, or the like. When the bonding of the neighboring solid electrolyte layers 10 in the stacking direction is performed by the heat welding, the welded region may be taken wide and then cut. In addition, when a non-woven fabric is used as the porous substrate 15 and the neighboring solid electrolyte layers 10 in the stacking direction are bonded by the heat welding, the bonding region 12b preferably becomes a resin with no cavity and exhibits insulation.

The solid-state battery 100 is manufactured through the above-mentioned processes.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A solid-state battery comprising: a plurality of (i) a positive electrode layer including a positive electrode active material layer and a positive electrode current collector layer, (ii) a negative electrode layer including a negative electrode active material layer and a negative electrode current collector layer, and (iii) a solid electrolyte layer disposed between the positive electrode layer and the negative electrode layer,
wherein the solid electrolyte layer is longer than the positive electrode layer and the negative electrode layer in a first direction perpendicular to a stacking direction,
the solid electrolyte layer is constituted by a solid electrolyte sheet including a porous substrate having cavities, and a solid electrolyte which is filled in at least a part of the porous substrate,
the solid electrolyte sheet has a facing portion that faces the positive electrode active material layer and the negative electrode active material layer, and a non-facing portion located on an outer side of the facing portion in the first direction,
a content percentage of the solid electrolyte in the non-facing portion is lower than a content percentage of the solid electrolyte in the facing portion, and
end portions in the first direction of the non-facing portions of the neighboring solid electrolyte layers in the stacking direction are bonded.

2. The solid-state battery according to claim 1, wherein, in a second direction perpendicular to the stacking direction and the first direction, the solid electrolyte layer is longer than the positive electrode active material layer and the negative electrode active material layer.

3. The solid-state battery according to claim 2, wherein the solid electrolyte layer further has a second-direction-non-facing portion located on an outer side of the facing portion in the second direction, and
a content percentage of the solid electrolyte in the second-direction-non-facing portion is lower than a content percentage of the solid electrolyte in the facing portion.

4. The solid-state battery according to claim 1, wherein, in the first direction crossing the stacking direction, the negative electrode layer is longer than the positive electrode layer,
the non-facing portion has an inner region which does not overlap the positive electrode layer and which overlaps the negative electrode layer, and an outer region located on an outer side of the inner region in the first direction, and
a content percentage of the solid electrolyte in the outer region is smaller than a content percentage of the solid electrolyte in the inner region.

5. The solid-state battery according to claim 1, wherein the non-facing portion of the solid electrolyte layer has a bonding region bonded to a non-facing portion of another solid electrolyte layer, and a non-bonding region closer to the facing portion than the bonding region in the first direction, and
a length of the non-bonding region in the first direction is greater than a thickness of the positive electrode active material layer.

6. The solid-state battery according to claim 1, wherein the negative electrode active material layer includes any one selected from the group consisting of an alloy obtained by combining metal lithium, lithium and another element or compound, and an alloy obtained by combining metal silicon, silicon and another element or compound, as a negative electrode active material.

7. The solid-state battery according to claim 1, wherein a porosity of the porous substrate in the non-facing portion is higher than a porosity of the porous substrate in the facing portion.
